(19) United States
(12) Patent Application Publication
(10) Pub. No.: US 2008/0087480 A1
(43) Pub. Date: Apr. 17, 2008

(54) Device for Generating Electrical Energy for an Agricultural or Industrial Utility Vehicle

(75) Inventors: Nicolai Tarasinski, Frankenthal (DE); Joachim Sobotzik, Lambsheim (DE); Marco Reinards, Bleialf (DE); Bernd Kneer, Viernheim (DE)

Correspondence Address: DEERE & COMPANY, ONE JOHN DEERE PLACE, MOLINE, IL, 61265, US

(73) Assignee: Deere & Company, Moline, IL (US)

(21) Appl. No.: 11/665,820

(22) PCT Filed: Oct. 10, 2005
(86) PCT No.: PCT/EP05/55123

§ 371 Date: Nov. 8, 2007

(30) Foreign Application Priority Data
Oct. 26, 2004 (DE) 10 2004 052 023.2

(51) Int. Cl. B60K 1/00

(52) U.S. Cl. 180/65.4

(57) ABSTRACT

The invention relates to a device for generating electrical energy for an agricultural or industrial commercial vehicle, comprising an electrical machine (18) which may be operated as a generator, which may be mechanically driven by an internal combustion engine (12) on the vehicle and which comprises a stator (22) and a rotor (20). A mechanical torque generated by the internal combustion engine (12) may be transmitted by a shaft (14, 38) to a gearbox (40) on the vehicle. The rotor (20) of the electrical machine (18) is fixed to a flywheel (16) or an output shaft (14) of the internal combustion engine (12). The rotor (20) has a hollow armature embodiment and the shaft (14, 26, 38) runs through the rotor (20). A damper (26) is provided between the internal combustion engine (12) and gearbox (40) for damping mechanical torque variations.

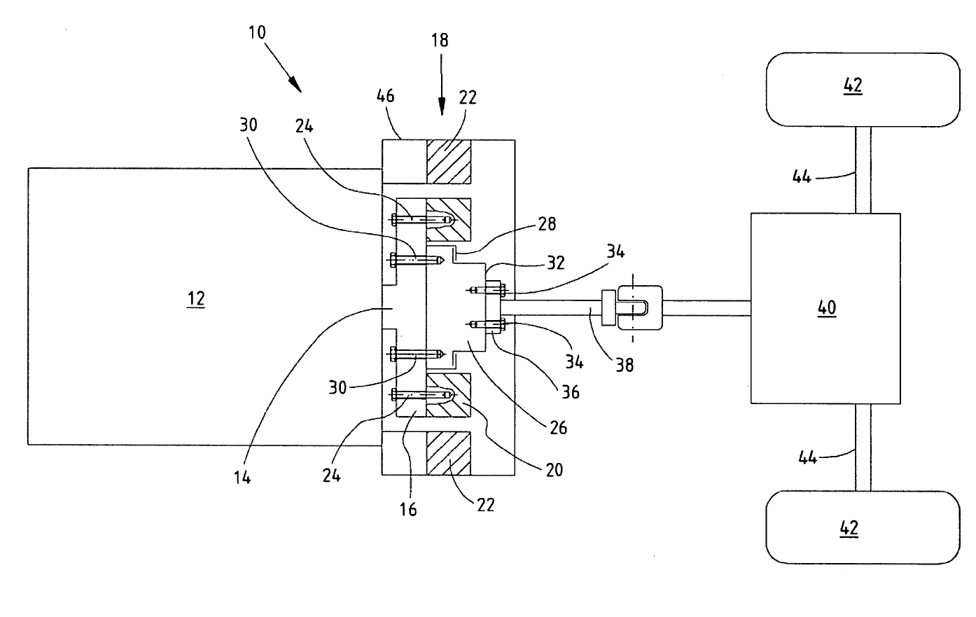

The invention relates to a device for generating electrical energy for an agricultural or industrial utility vehicle.

Such devices for generating electrical energy are known from the state of the art, especially in the form of dynamos. Dynamos are typically driven by means of a belt in motor vehicles.

Mechanically directly driven electric generators, so-called crankshaft generators or starter dynamos, are also known, which are arranged in the drive train between the internal combustion engine and the vehicle gearbox. Such crankshaft generators are used as, among other things, starter dynamos. One example of such a configuration is known from DE 32 30 607 C2, where the armature or rotor of this electric machine can form a component of the flywheel of the internal combustion engine. Possible non-uniformities in the drive train are minimized on the electromagnetic path in that the dynamo is operated such that it has a load moment that counteracts the non-uniformities. Accordingly, the electric motor provided there during the running operation of the vehicle cannot be used without restrictions on generating electrical energy.

Therefore, the objective of the present invention is to specify and improve a device of the type named above, by which means the previously mentioned problems are solved. In particular, unrestricted operation of the electric motor should be possible and nevertheless, possibly occurring torque variations in the drive train should be suppressed at least to a great extent.

The objective is realized according to the teaching of claim 1. Additional advantageous configurations and improvements of the invention emerge from the subordinate claims.

The device according to the invention for generating electrical energy for an agricultural or industrial utility vehicle comprises an electric motor, which can be operated as a generator and which can be mechanically driven by an internal combustion engine of the vehicle. The electric motor has a stator and a rotor. A mechanical torque generated by the internal combustion engine can be transferred via a shaft to a gearbox of the vehicle. The rotor of the electric motor can be locked in rotation with a flywheel or an output shaft of the internal combustion engine. The rotor is constructed as a hollow armature. The shaft or a component transmitting torque extends through the rotor. A damper for damping mechanical torque variations is provided between the internal combustion engine and the gearbox.

In the course of the invention, it was initially recognized that installation space could be saved merely through the arrangement of the individual components or that the drive train could be built more compactly, and nevertheless the full functionality of the individual components and/or the overall arrangement could be made available. Thus, the correspondingly designed mechanically directly driven electric motor could generate a given high electrical output without having to take into account power losses due to a belt drive. Also, with the electric motor, the mechanical torque variations in the drive train do not have to be suppressed—especially between the internal combustion engine and the gearbox—because a damper is specifically provided for this purpose. This produces in the end increased travel comfort in the vehicle. Because the rotor of the electric motor is constructed in the form of a hollow armature, for example, the damper can extend at least partially into this cavity, by means of which installation space can be advantageously saved. The individual components can be arranged in parallel with respect to the transmission of torque from the internal combustion engine, namely when both the rotor constructed as a hollow armature for the electric motor and also the damper are arranged locked in rotation at least with one housing side on a flywheel of the internal combustion engine. In this respect, non-uniformities in the drive train can be minimized or suppressed, wherein the electric motor can be used independently for generating electrical energy.

It is especially preferred if the damper has a torsional oscillation damper. A torsional oscillation damper involves a component, which is arranged in a drive train, preferably between a motor and a shaft to be driven, which can be connected to a gearbox. Arbitrary components can be provided between the torsional oscillation damper and the motor as well as the shaft to be driven. Torsional oscillation dampers are known in a plurality of constructions and merely as an example, reference is made to DE 28 48 748.1. A torsional oscillation damper therefore actually damps torque variations or torque peaks, in that it consumes, for example, mechanical energy or converts it into work due to friction. In contrast to this arrangement and therefore less preferred, the damper could have a torsional oscillation absorber, which therefore reduces torque variations or torque peaks in that it converts these into opposite-phase oscillations.

The damper could be arranged locked in rotation with at least one housing side on the flywheel or on the output shaft of the internal combustion engine. With its other housing side, the damper would then be arranged locked in rotation on the shaft, which connects to an input shaft of the gearbox. An attachment of the one housing part of the damper to the flywheel can be realized in an especially advantageous way structurally easily, for example, by means of screw connections.

As already indicated, in an especially advantageous way, installation space can be saved when the damper is arranged at least partially within the rotor of the electric motor or extends at least partially into the rotor. Finally, a modular construction is also possible in an especially advantageous way.

In detail, the stator of the electric motor could be arranged on the housing of the internal combustion engine. This is provided especially when the rotor of the electric motor is arranged locked in rotation on the flywheel of the internal combustion engine. Preferably, the internal combustion engine can be installed with an installed electric motor in or on a frame of the vehicle.

In an especially preferred concrete embodiment, the vehicle embodied in the form of a tractor has a separate chassis and body construction. This is to be understood, in particular, in that, on the one hand, the internal combustion engine is fixed to the frame of the vehicle and, on the other hand, the gearbox is fixed to a different position on the frame. This does not involve a block construction of the internal combustion engine and gearbox, in which the gearbox is fixed directly to the internal combustion engine housing, i.e., on the block, as it were. Accordingly, as a function of the attachment of the internal combustion engine and the gearbox on the vehicle frame, the internal combustion engine is movably arranged relative to the gearbox. If the relative movements between the gearbox and internal combustion engine exceed a certain threshold, it is advantageous if the shaft transmitting the mechanical torque between the internal combustion engine and gearbox has a universal-joint propeller shaft.

It is especially preferred that the electric motor has an asynchronous motor or operates according to the principle of an asynchronous motor.

In a preferred embodiment at least one current inverter or converter could be provided. Because the electrical current is generated with the aid of the electric motor operating as a generator, which is driven by the internal combustion engine of the vehicle, and the internal combustion engine has a variable rotational speed as a function of the current driving situation of the vehicle, the electrical alternating current generated by the generator has a variable frequency. Such a current inverter could be used for converting the electrical alternating current of variable frequency into electrical alternating current of a given, essentially constant frequency. With the current inverter, the electrical alternating current of variable frequency generated by the electric generator could be first converted into direct current and then into alternating current of a given frequency. With this alternating current, for example, electrical components could then be driven, which are constructed preferably as asynchronous motors. Preferably, a direct current loop with at least one electrical storage device is provided. This direct current loop is powered by the current inverter and could be used, so to speak, as an intermediate current loop, to which electrical loads operating with direct current could also be connected directly. The electrical storage device could be constructed, for example, in the form of a battery or accordingly dimensioned capacitors.

In a similarly especially preferred way, at least one additional current inverter is provided, with which the direct current can be converted into alternating current of a given frequency or a given profile of variable frequency. Here, for example, at least one electrical load can be operated that is driven with alternating current.

Now the current inverter and the additional current inverter and also optionally other power electronics components could be combined spatially in one assembly. In this way, installation space can also be saved advantageously, and simple and quick assembly is possible. A modular construction of the assembly is possible, especially if the assembly comprises a base body to which the individual components are adapted. For this purpose, means could be provided on the base body, through which the electrical components can be attached to the base plate. Such means could be constructed, for example, in the form of bores and/or plug-in contacts.

So that sufficient cooling of the power electronics components is guaranteed when the vehicle is running, in an especially preferred way the assembly and/or the base body is or are water-cooled. This could be realized, for example, such that the assembly can be cooled from at least one side—for example, from the base body—with water or another coolant.

In an especially economical way, the electronic components can be cooled if the otherwise already existing coolant circuit of the vehicle is also used for cooling the assembly. For this purpose, a connection line could branch off at a corresponding position of the coolant circuit of the vehicle and could be led to the electronic components or to the base body. The base body could also have in this case the function of a heat exchanger, which dissipates the heat to the coolant flowing through it. This coolant can then be fed back to the coolant circuit of the vehicle by means of another line.

So that the device according to the invention can be used especially in an agricultural utility vehicle, in which the vehicle is operated on land, preferably the assembly can be protected from environmental effects by a housing. This involves primarily protection from water, humidity, mud, and dust.

In another preferred embodiment, the provided power electronics components and/or electrical loads have a modular construction. In this way, lines of vehicles of different power classes can be configured economically and mass produced.

For powering at least one external electrical load, a converter module could be provided, with which an electrical power interface can be powered. The electrical load can be connected to the electrical power interface, for example, in the form of a plug receptacle. This converter module could convert the direct current applied in a direct current network, for example, into alternating current of 220 V and 50 Hz.

In this connection, the converter module could be controlled via a data interface such that a given voltage and/or a given frequency could be generated by the converter module. This data interface could be constructed in the form of a CAN bus (Controller Area Network), which controls the converter module depending, for example, on the provided interface connection or the plug of the electrical load, such that electrical power in the mode and optionally frequency necessary for the load is guaranteed.

Now there are various possibilities for reducing to practice and improving the teaching of the present invention in advantageous ways. Here, on the one hand, refer to the claims following Claim 1 and, on the other hand, refer to the following explanation of the preferred embodiment of the invention with reference to the drawing. In connection with the explanation of the preferred embodiment of the invention with reference to the drawing, preferred constructions and improvements of the teaching are also explained in general. Shown in the drawing is the sole FIGURE:

FIGURE, in a schematic view, an embodiment of the present invention.

In the sole FIGURE, the drive train for an agricultural utility vehicle not shown in the FIGURE is designated with the reference symbol 10. The drive train 10 comprises an internal combustion engine 12 that has an output shaft 14, on which the flywheel 16 is arranged locked in rotation. An electric motor 18, which is constructed in the form of an asynchronous motor and which has a rotor 20 and a stator 22, is provided. The electric motor 18 can be operated as a generator. For this purpose—assuming a corresponding connection of the electric motor 18—the rotor 20 is driven mechanically via the shaft 14 and the flywheel 16 by the internal combustion engine 12. The rotor 20 of the electric motor 18 is locked in rotation to the flywheel 16 via screw connections 24. The rotor 20 is constructed as a hollow armature essentially involving an annular component. Accordingly, a shaft or an assembly transmitting a torque can extend through the rotor 20. The shaft is then used for transmitting the mechanical torque generated by the internal combustion engine 12 to a drive or to a gearbox.

A damper 26, which is constructed in the form of a torsional oscillation damper and with which torque variations or torque peaks can be suppressed in the drive train 10, is provided. It is indicated merely schematically that the damper 26 has a two-part housing. The first housing part 28 of the damper 26 is attached by means of the connection screws 30 to the flywheel 16. The second housing part 32 of the damper 26 is locked in rotation to the flange 36 of the universal-joint propeller shaft 38 via the connection screws 34. The first housing part 28 can be rotated relative to the second housing part 32 against a corresponding torsional force of a given characteristic line, which is possible through the inner construction of the torsional oscillation damper 26 (not shown in more detail in the FIGURE). Because the internal combustion engine 12 is connected to the gearbox 40, among other things, via the universal joint propeller shaft 38, the internal combustion engine 12 can move relative to the gearbox 40.

The internal combustion engine 12 generates a torque, which is transmitted via the shaft 14, the flywheel 16, the damper 36, and the universal-joint propeller shaft 38 to the gearbox 40. The gearbox 40 is driven with this torque. The gearbox 40 is constructed in the form of a power-shift gearbox with group gears. In addition, the gearbox 40 comprises a differential (not drawn separately merely for the sake of simplicity), which distributes the mechanical torque input into the gearbox 40 to the two drive wheels 42 via the shafts 44.

It is indicated merely schematically that the stator 22 of the electric motor 18 is fixed in a stator housing 46 directly on the housing of the internal combustion engine 12. This can also be realized by means of screw connections (which are not shown, however, due to the simple representation).

At this point it should be stressed once again that in the embodiment shown in the sole FIGURE, both the rotor 20 of the electric motor 18 and also the damper 26 are arranged locked in rotation directly on the flywheel 16. Accordingly, in terms of the torque balance of the mechanical loads, the electric motor 18 is arranged parallel to the mechanical drive or damper 26.

In conclusion, it should be noted in particular that the previously explained embodiment is used merely for describing the claimed teaching, but the teaching is not restricted to this embodiment.

1. Device for generating electrical energy for an agricultural or industrial utility vehicle, with an electric motor (18), which can be operated as a generator and which can be driven mechanically by an internal combustion engine (12) of the vehicle and which has a stator (22) and a rotor (20), wherein a mechanical torque generated by the internal combustion engine (12) can be transmitted via a shaft (14, 38) to a gearbox (40) of the vehicle, wherein the rotor (20) of the electric motor (18) can be arranged locked in rotation on a flywheel (16) or on an output shaft (14) of the internal combustion engine (12), wherein the rotor (20) is constructed as a hollow armature and the shaft (14, 26, 38) extends through the rotor (20), and wherein a damper (26) is provided for damping mechanical torque variations between the internal combustion engine (12) and the gearbox (40).

2. Device according to claim 1, wherein the damper (26) has a torsional oscillation damper.

3. Device according to claim 1 or 2, wherein the damper (26) is arranged locked in rotation on the flywheel (16) or on the output shaft (14) of the internal combustion engine (12).

4. Device according to one of claims 1-3, wherein the damper (26) is arranged at least partially within the rotor (20) of the electric motor (18).

5. Device according to one of claims 1-4, wherein the stator (22) of the electric motor (18) is arranged on the housing of the internal combustion engine (12).

6. Device according to one of claims 1-5, wherein the internal combustion engine (12) can be installed with an installed electric motor (18) on a frame of the vehicle.

7. Device according to one of claims 1-6, wherein the internal combustion engine (12) is movably arranged relative to the gearbox (40).

8. Device according to one of claims 1-7, wherein the shaft (38) transmitting the mechanical torque between the internal combustion engine (12) and the gearbox (40) has a universal-joint propeller shaft.

9. Device according to one of claims 1-8, wherein the electric motor (18) has an asynchronous motor.

10. Device according to one of claims 1-9, wherein at least one current inverter is provided, with which the electrical alternating current of variable frequency generated by the electric motor (18) can be converted into direct current, wherein preferably a direct current loop is provided with at least one electrical storage device.

11. Device according to one of claims 1-10, wherein at least one additional current inverter is provided, with which the direct current can be converted into an alternating current of a given frequency or a given profile of variable frequencies, with which preferably at least one electrical load can be operated.

12. Device according to one of claims 1-11, wherein the current inverter and the additional current inverter and also optionally other power electronics components are combined spatially into one assembly, wherein the assembly preferably comprises a base body.

13. Device according to claim 12, wherein the base body has means, preferably in the form of bores, through which the electric components can be attached to the base plate.

14. Device according to one of claims 1-13, wherein the assembly and/or the base body is water-cooled, such that the assembly can be water-cooled from at least one side, for example, from a base body.

15. Device according to one of claims 1-14, wherein the water-cooling of the vehicle can also be used for cooling the assembly, preferably by means of a line branching from a coolant circuit of the vehicle.

16. Device according to one of claims 1-15, wherein the assembly can be protected from environmental effects by a housing.

17. Device according to one of claims 1-16, wherein provided power electronics components and/or electrical loads have a modular construction.

18. Device according to one of claims 1-17, wherein a converter module is provided, with which an electrical power interface can be powered, which is preferably provided for powering at least one external electrical load.

19. Device according to claim 18, wherein the converter module can be controlled via a data interface, such that a given voltage and/or a given frequency can be generated by the converter module, wherein the data interface preferably has a CAN bus.
